(19) United States
(12) Patent Application Publication
(10) Pub. No.: US 2025/0306495 A1
(43) Pub. Date: Oct. 2, 2025

(54) IMAGE FORMING SYSTEM

(71) Applicant: FUJIFILM Business Innovation Corp., Tokyo (JP)

(72) Inventors: Ayaka MIYOSHI, Kanagawa (JP); Daisuke TANAKA, Kanagawa (JP)

(73) Assignee: FUJIFILM Business Innovation Corp., Tokyo (JP)

(21) Appl. No.: 18/764,162

(22) Filed: Jul. 4, 2024

(30) Foreign Application Priority Data
Mar. 27, 2024 (JP) 2024-052303

(51) Int. Cl. G03G 15/01; G03G 15/00

(52) U.S. Cl. CPC G03G 15/0131; G03G 15/0189; G03G 15/5029

(57) ABSTRACT

An image forming system includes plural image holding bodies that hold an image, an intermediate transfer body that rotates and to which the image formed on the plural image holding bodies is transferred, plural transfer members that transfer the image formed on the plural image holding bodies to the intermediate transfer body, a first surface forming member that is disposed upstream the plural image holding bodies in a rotation direction of the intermediate transfer body, and a second surface forming member that is disposed downstream the plural image holding bodies in the rotation direction, and stabilizes surface formation of the intermediate transfer body together with the first surface forming member, in which the first surface forming member and the second surface forming member are disposed such that a pressure of a transfer portion formed by the image holding bodies and the transfer member via the intermediate transfer body is high in a transfer portion positioned most downstream as compared with a transfer portion positioned most upstream in the rotation direction.

### CROSS-REFERENCE TO RELATED APPLICATIONS

This application is based on and claims priority under 35 USC 119 from Japanese Patent Application No. 2024-052303 filed Mar. 27, 2024.

### BACKGROUND

### (i) Technical Field

The present disclosure relates to an image forming system.

### (ii) Related Art

JP2006-18177A discloses an image forming apparatus including an image carrying body that carries a developer image, a belt body that is used to transfer the developer image on the image carrying body, and a transfer member that is into contact with a back surface of the belt body, in which the image carrying body is in contact with a front surface of the belt body, and, in a contact region between the image carrying body and the belt body in a movement direction of the belt body, the belt body is in contact with the transfer member in an area on a downstream side in the movement direction of the belt body, and the belt body is not in contact with the transfer member in an area on an upstream side in the movement direction of the belt body.

### SUMMARY

Aspects of non-limiting embodiments of the present disclosure relate to an image forming system that suppresses a color variation of an image transferred to an intermediate transfer body as compared with a configuration in which a surface forming member for stabilizing surface formation of the intermediate transfer body is disposed such that a pressure in a transfer portion formed with an image holding body and a transfer member via the intermediate transfer body is the same between a transfer portion positioned most upstream and a transfer portion positioned most downstream in a rotation direction of the intermediate transfer body.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provide an image forming system includes a plurality of image holding bodies that hold an image, an intermediate transfer body that rotates and to which the image formed on the plurality of image holding bodies is transferred, a plurality of transfer members that transfer the image formed on the plurality of image holding bodies to the intermediate transfer body, a first surface forming member that is disposed upstream the plurality of image holding bodies in a rotation direction of the intermediate transfer body, and a second surface forming member that is disposed downstream the plurality of image holding bodies in the rotation direction, and stabilizes surface formation of the intermediate transfer body together with the first surface forming member, in which the first surface forming member and the second surface forming member are disposed such that a pressure of a transfer portion formed by the image holding bodies and the transfer member via the intermediate transfer body is high in a transfer portion positioned most downstream as compared with a transfer portion positioned most upstream in the rotation direction.

### BRIEF DESCRIPTION OF THE DRAWINGS

Exemplary embodiment(s) of the present invention will be described in detail based on the following figures, wherein:

FIG. 1 is a schematic view showing an image forming apparatus according to an exemplary embodiment of the present disclosure;

FIG. 2 is a block diagram showing a hardware configuration of the image forming apparatus according to the exemplary embodiment of the present disclosure;

FIG. 3 is a schematic view showing a relationship between a virtual surface and a contact surface of the image forming apparatus according to the exemplary embodiment of the present disclosure;

FIG. 4 is an enlarged view of a periphery of a first surface forming member of the image forming apparatus shown in FIG. 1;

FIG. 5 is an enlarged view of a periphery of a second surface forming member of the image forming apparatus shown in FIG. 1;

FIG. 6 is an enlarged view of a transfer portion (nip portion) positioned most downstream the image forming apparatus shown in FIG. 1;

FIG. 7 is an enlarged view of a transfer portion (nip portion) positioned most upstream the image forming apparatus shown in FIG. 1;

FIG. 8 is a flowchart for explaining an operation in a case of performing positional adjustment of each of the first surface forming member and the second surface forming member of the image forming apparatus according to the exemplary embodiment of the present disclosure;

FIG. 9 is a graph showing a situation of improvement of a primary transfer rate in a case where the image forming apparatus according to the exemplary embodiment of the present disclosure is used;

FIG. 10 is a graph showing a situation of improvement of a toner charging amount in the case where the image forming apparatus according to the exemplary embodiment of the present disclosure is used;

FIG. 11 is a graph showing a situation of improvement of a position of the second surface forming member with respect to the virtual surface and the primary transfer rate in a 4 axial direction in the image forming apparatus according to the exemplary embodiment of the present disclosure;

FIG. 12 is a graph showing a relationship between a toner particle diameter and a nip pressure of a primary transfer roll in a case where the image forming apparatus according to the exemplary embodiment of the present disclosure is used;

FIG. 13 is a graph showing a relationship between a paper type or a paper thickness and the nip pressure in the primary transfer roll in the case where the image forming apparatus according to the exemplary embodiment of the present disclosure is used;

FIG. 14 is a flowchart for explaining an operation in a case of performing positional adjustment of each of a first surface forming member and a second surface forming member of an image forming apparatus according to another exemplary embodiment of the present disclosure; and

FIG. 15 is a flowchart for explaining an operation in a case of performing positional adjustment of each of a first surface forming member and a second surface forming member of an image forming apparatus according to still another exemplary embodiment of the present disclosure.

### DETAILED DESCRIPTION

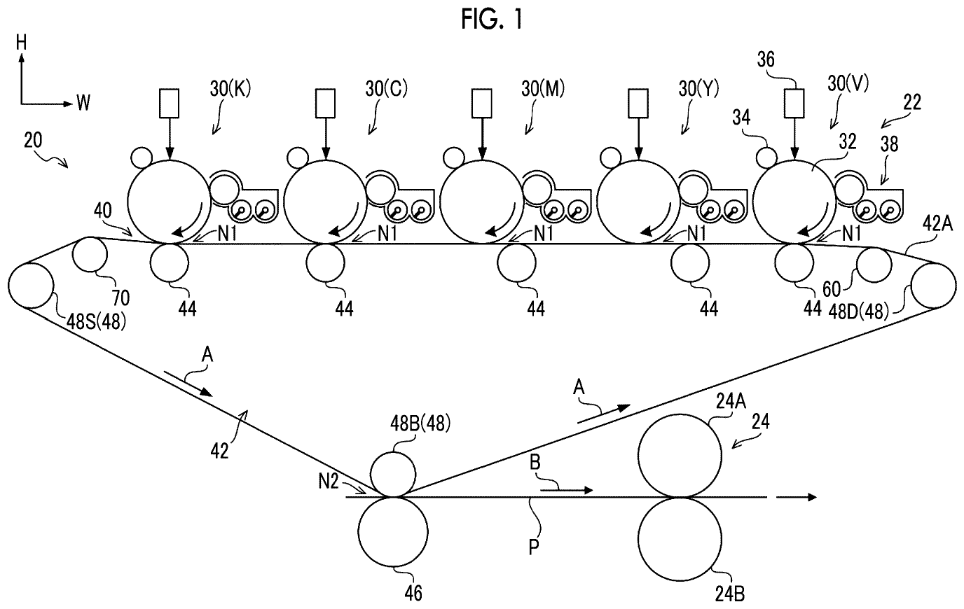

An image forming apparatus 20 as an example of an image forming system according to an exemplary embodiment of the present disclosure will be described with reference to FIGS. 1 to 7.

An arrow H shown in each of the drawings indicates an apparatus up and down direction (specifically, a vertical direction) of the image forming apparatus 20. An arrow W indicates an apparatus width direction (specifically, a horizontal direction) of the image forming apparatus 20. An arrow D indicates an apparatus depth direction (specifically, a horizontal direction) of the image forming apparatus 20. The apparatus up and down direction, the apparatus width direction, and the apparatus depth direction of the image forming apparatus 20 intersect with each other (specifically, orthogonal to each other). The present disclosure is not limited to the configuration, and the apparatus width direction may be the apparatus depth direction, and the apparatus depth direction may be the apparatus width direction.

In addition, components indicated by the identical reference numerals in the respective drawings mean the identical or similar components. In the exemplary embodiments described below, the repeated description and reference numerals may be omitted. In addition, the drawings used in the following description are all schematic, and the relationship between respective dimensions of elements, the ratio between the respective elements, and the like shown in the drawings do not always coincide with the reality. In addition, even between a plurality of drawings, the relationship between the respective dimensions of the elements, the ratio between the respective elements, and the like do not always coincide with each other.

As shown in FIG. 1, the image forming apparatus 20 according to the present exemplary embodiment is an apparatus that forms an image on a recording medium P. Specifically, the image forming apparatus 20 is an electrophotographic image forming apparatus that forms a toner image (an example of the image) on the recording medium P. In the present exemplary embodiment, paper is used as an example of the recording medium P but the present disclosure is not limited thereto.

The image forming apparatus 20 includes an image forming portion 22 and a fixing portion 24. Hereinafter, each of the portions (the image forming portion 22 and the fixing portion 24) of the image forming apparatus 20 will be described.

### Image Forming Portion 22

As shown in FIG. 1, the image forming portion 22 has a function of forming the toner image on the recording medium P. Specifically, the image forming portion 22 includes a plurality of image forming units 30 and a transfer portion 40.

The plurality of image forming units 30 are provided on a surface 42A of a transfer belt 42, which will be described later, at intervals in a circumferential direction A of the transfer belt 42. The plurality of image forming units 30 form toner images of different colors on the surface 42A of the transfer belt 42. The image forming units 30 are arranged in order of V (vermilion), Y (yellow), M (magenta), C (cyan), and K (black) from upstream in the circumferential direction A.

As shown in FIG. 1, each of the image forming units 30 is configured in the same manner except a toner to be used. Therefore, in FIG. 1, each of the portions of the image forming unit 30 (V) is denoted by reference numeral in place of each image forming unit 30.

Each image forming unit 30 includes a photosensitive drum 32 as an example of an image holding body having a function of holding a toner image (image). The photosensitive drum 32 rotates in one direction (for example, a clockwise direction in FIG. 1).

Further, each image forming unit 30 includes a charger 34, an exposure device 36, and a development device 38.

In each image forming unit 30, the charger 34 charges the photosensitive drum 32. In addition, the exposure device 36 exposes the photosensitive drum 32 charged by the charger 34 to form an electrostatic latent image on the photosensitive drum 32. In addition, the development device 38 develops the electrostatic latent image formed on the photosensitive drum 32 by the exposure device 36 to form the toner image.

The photosensitive drum 32 is rotated while holding the electrostatic latent image formed as described above on the outer circumference, and the electrostatic latent image is transported to the development device 38.

As shown in FIG. 1, the transfer portion 40 has a function of transferring the toner image formed by the image forming units 30 to the recording medium P. Specifically, the transfer portion 40 performs primary transfer of the toner image of each photosensitive drum 32 to be superimposed on the transfer belt 42 as an example of an intermediate transfer body, and performs secondarily transfer of the superimposed toner image to the recording medium P. Specifically, as shown in FIG. 1, the transfer portion 40 includes a transfer belt 42, a primary transfer roll 44, and a secondary transfer roll 46.

The primary transfer roll 44 is a roll that transfers the toner image of each photosensitive drum 32 to the transfer belt 42 at a nip portion N1 between the photosensitive drum 32 and the primary transfer roll 44. In the present exemplary embodiment, a primary transfer electric field is applied between the primary transfer roll 44 and the photosensitive drum 32, so that the toner image formed on the photosensitive drum 32 is transferred to the transfer belt 42 at the nip portion N1. The primary transfer roll 44 is an example of a transfer member.

The toner image is transferred to the surface 42A of the transfer belt 42 as an outer circumferential surface from each of the photosensitive drums 32. As shown in FIG. 1, the transfer belt 42 is an endless belt body having an annular shape, and a posture of which is determined by beings wound around a plurality of rolls 48.

In the transfer belt 42, among the plurality of rolls 48, for example, a driving roll 48D is rotationally driven by a driving force from a drive source (not shown) to circulate in the direction of the arrow A. In addition, among the plurality of rolls 48, a roll 48S shown in FIG. 1 is a steering roll 48S as an example of a suppression mechanism that suppresses the inclination of the transfer belt 42 (the movement of the transfer belt 42 in the width direction, in other words, the movement of the roll 48 in the axial direction). The steering roll 48S is positioned downstream the second surface forming roll 70, which will be described later, in the circumferential direction A. In addition, among the plurality of rolls 48, a roll 48B shown in FIG. 1 is a facing roll 48B that faces the secondary transfer roll 46.

The secondary transfer roll 46 is a roll that transfers the toner image transferred to the transfer belt 42 to the recording medium P at a nip portion N2 between the facing roll 48B and the secondary transfer roll 46. In the present exemplary embodiment, a secondary transfer electric field is applied between the facing roll 48B and the secondary transfer roll 46, so that the toner image transferred to the transfer belt 42 is transferred to the recording medium P at the nip portion N2.

In addition, as shown in FIG. 1, the transfer portion 40 includes a first surface forming roll 60 and a second surface forming roll 70. The first surface forming roll 60 is an example of a first surface forming member. In addition, the second surface forming roll 70 is an example of a second surface forming member.

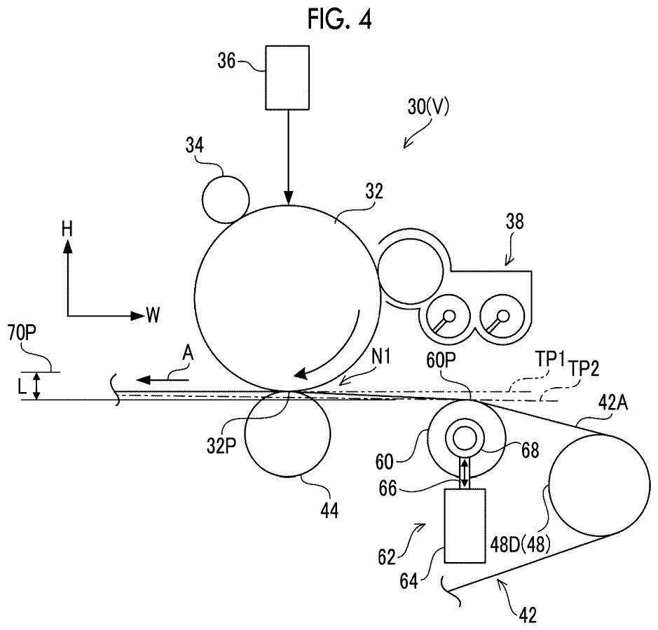

The first surface forming roll 60 is disposed upstream each image forming unit 30 in the circumferential direction A. Specifically, as shown in FIG. 4, the first surface forming roll 60 is disposed between the image forming unit 30 (V), which is positioned most upstream in the circumferential direction A in each image forming unit 30, and the driving roll 48D.

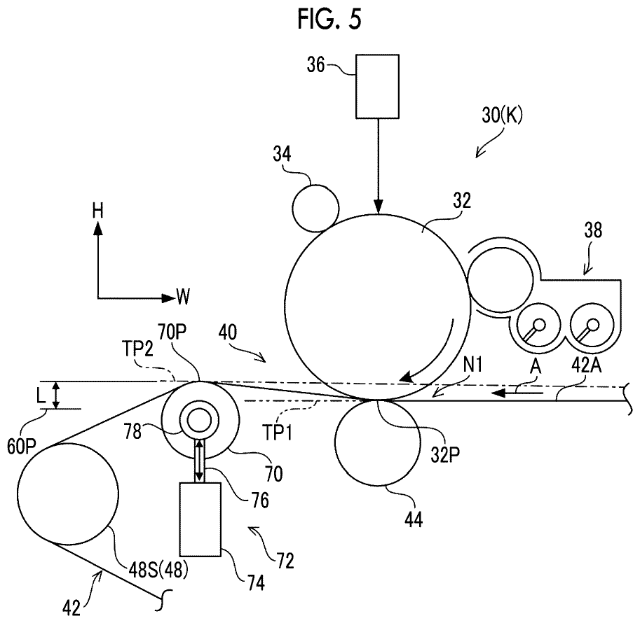

The second surface forming roll 70 is disposed downstream each image forming unit 30 in the circumferential direction A. Specifically, as shown in FIG. 5, the second surface forming roll 70 is disposed between the image forming unit 30 (K), which is positioned most downstream in the circumferential direction A in each image forming unit 30, and the steering roll 48S.

The first surface forming roll 60 and the second surface forming roll 70 have a function of supporting the transfer belt 42 from an inner surface side and stabilizing surface formation of the transfer belt 42.

The first surface forming roll 60 and the second surface forming roll 70 are disposed such that a pressure of the nip portion N1 as the transfer portion formed by the photosensitive drum 32 and the primary transfer roll 44 via the transfer belt 42 is higher at the nip portion N1 positioned most downstream than the nip portion N1 positioned most upstream in the circumferential direction A.

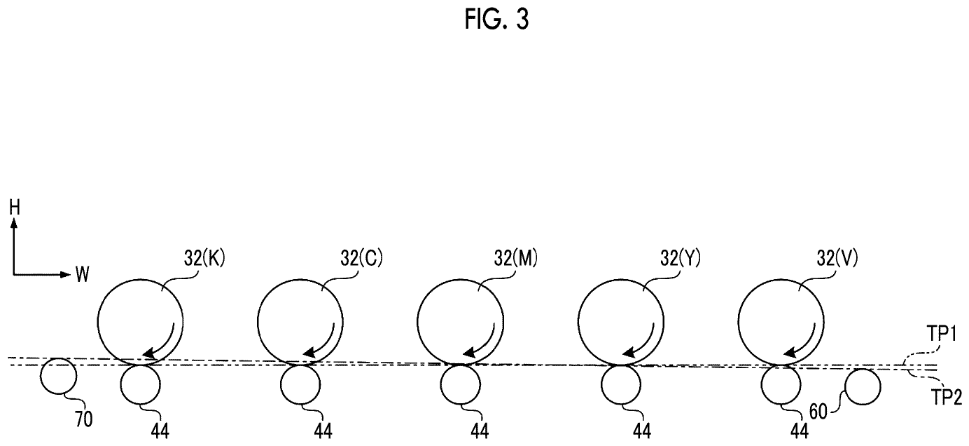

Specifically, as shown in FIGS. 3 to 5, a contact surface TP2 that is in contact with each of the apexes 60P and 70P of the first surface forming roll 60 and the second surface forming roll 70 is disposed to be in a state of being inclined with respect to a virtual surface TP1 which is in contact with an apex 32P of the photosensitive drum 32. The apex 60P of the first surface forming roll 60 is an apex on a side opposite to the primary transfer roll 44, and is an apex on an upper side in the apparatus up and down direction in the present exemplary embodiment. In addition, the apex 70P of the second surface forming roll 70 is an apex on a side opposite to the primary transfer roll 44, and is an apex on an upper side in the apparatus up and down direction in the present exemplary embodiment. In addition, the apex 32P of the photosensitive drum 32 is an apex on a side of the primary transfer roll 44 and is an apex on a lower side in the apparatus up and down direction.

More specifically, a contact portion of the first surface forming roll 60 with the transfer belt 42 is disposed on a side of the primary transfer roll 44 rather than the virtual surface TP1 (see FIG. 4). A contact portion of the second surface forming roll 70 with the transfer belt 42 is disposed on a side opposite to the side of the primary transfer roll 44 rather than the virtual surface TP1 (see FIG. 5).

In the present exemplary embodiment, as described above, the first surface forming roll 60 and the second surface forming roll 70 are disposed such that the pressure of the nip portion N1 is high in the nip portion N1 positioned on a downstream side as compared with the nip portion N1 positioned on an upstream side in the circumferential direction A, but the present disclosure is not limited to this configuration.

In addition, as shown in FIGS. 4 and 5, the transfer portion 40 includes a first movement mechanism 62 and a second movement mechanism 72.

The first movement mechanism 62 has a function of moving the first surface forming roll 60 to the side of the primary transfer roll 44 with respect to the virtual surface TP1. As the first movement mechanism 62, for example, a mechanism, such as a ball screw mechanism, a cam mechanism, a rack and pinion mechanism, a belt and pulley mechanism, a sprocket and chain mechanism, or a gear mechanism, which uses an electric motor, an electric actuator, or the like as a drive source, may be used.

As an example, the first movement mechanism 62 according to the present exemplary embodiment includes a body portion 64 that is directly or indirectly attached to the body of the image forming apparatus 20, and a movement portion 66 that moves relative to the body portion 64. More specifically, as shown in FIG. 4, in the first movement mechanism 62, the body portion 64 is directly or indirectly fixed to the body of the image forming apparatus 20, and the movement portion 66 moves in the apparatus up and down direction with respect to the body portion 64.

The inside of the body portion 64 is provided with a drive source (not shown) for relatively moving the movement portion 66 with respect to the body portion 64. In addition, the drive source of the body portion 64 is controlled by a processor 100 which will be described later. Accordingly, the relative movement amount of the movement portion 66 with respect to the body portion 64 is controlled by the processor 100.

A pair of bearing portions 68 that rotatably support the first surface forming roll 60 are provided at a tip end portion of the movement portion 66.

The second movement mechanism 72 has a function of moving the second surface forming roll 70 to a side opposite to the side of the primary transfer roll 44 with respect to the virtual surface TP1. As the second movement mechanism 72, for example, a mechanism, such as a ball screw mechanism, a cam mechanism, a rack and pinion mechanism, a belt and pulley mechanism, a sprocket and chain mechanism, or a gear mechanism, which uses an electric motor, an electric actuator, or the like as a drive source, may be used.

As an example, the second movement mechanism 72 according to the present exemplary embodiment includes a body portion 74 that is directly or indirectly attached to the body of the image forming apparatus 20, and a movement portion 76 that is moved relative to the body portion 74. More specifically, as shown in FIG. 5, in the second movement mechanism 72, the body portion 74 is directly or indirectly fixed to the body of the image forming apparatus 20, and the movement portion 76 moves in the apparatus up and down direction with respect to the body portion 74.

The inside of the body portion 74 is provided with a drive source (not shown) for relatively moving the movement portion 76 with respect to the body portion 74. In addition, the drive source of the body portion 74 is controlled by the processor 100 which will be described later. Accordingly, the relative movement amount of the movement portion 66 with respect to the body portion 74 is controlled by the processor 100.

A pair of bearing portions 78 that rotatably support the second surface forming roll 70 are provided at a tip end portion of the movement portion 76.

The inclination of the contact surface TP2 with respect to the virtual surface TP1 is changed by adjusting the positions of the first surface forming roll 60 and the second surface forming roll 70 with respect to the virtual surface TP1 by the first movement mechanism 62 and the second movement mechanism 72. The contact pressure of the transfer belt 42 with respect to the photosensitive drum 32 is changed by changing the inclination of the contact surface TP2 with respect to the virtual surface TP1. That is, the contact pressure of the transfer belt 42 with respect to the photosensitive drum 32 can be adjusted by adjusting the inclination of the contact surface TP2 with respect to the virtual surface TP1.

As shown in FIG. 3, in the present exemplary embodiment, the contact portion of the first surface forming roll 60 with the transfer belt 42 is disposed on the upper side than the virtual surface TP1 in the apparatus up and down direction, and the contact portion of the second surface forming roll 70 with the transfer belt 42 is disposed on the lower side than the virtual surface TP1 in the apparatus up and down direction. Therefore, the contact surface TP2 is inclined from the lower right to the upper left in the circumferential direction A as seen in FIG. 3.

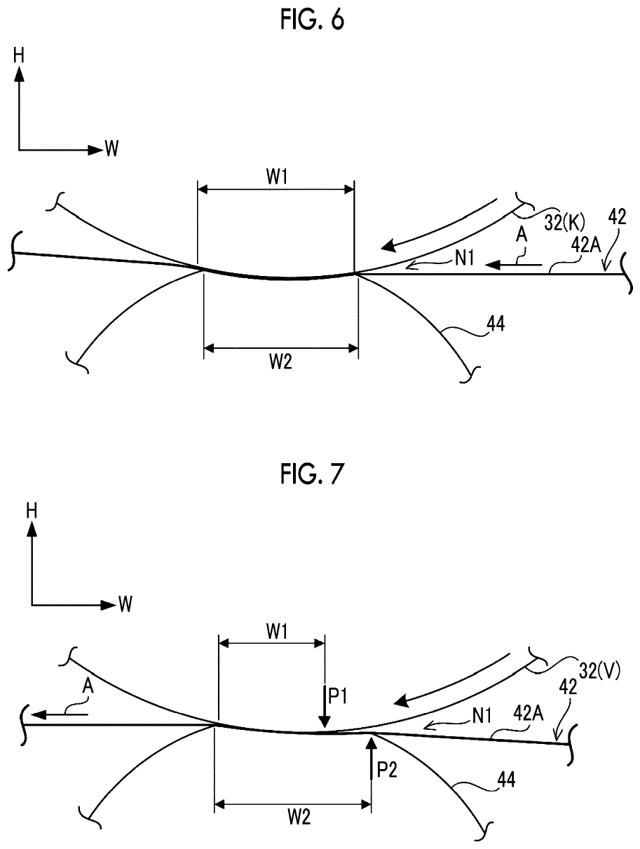

In the present exemplary embodiment, since the contact surface TP2 is inclined with respect to the virtual surface TP1 as described above, as shown in FIGS. 6 and 7, in the circumferential direction A, a nip width W1 positioned most downstream between the photosensitive drum 32 and the transfer belt 42 is larger than a nip width W1 positioned most upstream between the photosensitive drum 32 and the transfer belt 42. Specifically, the nip width W1 (K) is wider than the nip width W1 (V). In addition, in the circumferential direction A, a nip width W2 positioned most downstream between the primary transfer roll 44 and the transfer belt 42 is narrower than the nip width W2 positioned most upstream between the primary transfer roll 44 and the transfer belt 42. Specifically, the nip width W2 (K) is narrower than the nip width W2 (V).

In addition, in the present exemplary embodiment, in the photosensitive drums 32 adjacent to each other in the circumferential direction A, the nip width W1 positioned downstream between the photosensitive drum 32 and the transfer belt 42 may be wider than the nip width W1 positioned upstream between the photosensitive drum 32 and the transfer belt 42. For example, the nip width W1 (K) may be wider than the nip width W1 (C). In addition, in the primary transfer rolls 44 adjacent to each other in the circumferential direction A, the nip width W2 positioned downstream between the primary transfer roll 44 and the transfer belt 42 may be narrower than the nip width W2 positioned upstream between the primary transfer roll 44 and the transfer belt 42. For example, the nip width W2 (Y) may be narrower than the nip width W2 (V)

### Fixing Portion 24

As shown in FIG. 1, the fixing portion 24 has a function of fixing the toner image, which is transferred to the recording medium P by the secondary transfer roll 46, to the recording medium P. Specifically, the fixing portion 24 includes a heating roll 24A as a heating member and a pressure roll 24B as a pressurizing member. In the fixing portion 24, the recording medium P is heated and pressurized by the heating roll 24A and the pressure roll 24B, and thus the toner image formed on the recording medium P is fixed to the recording medium P.

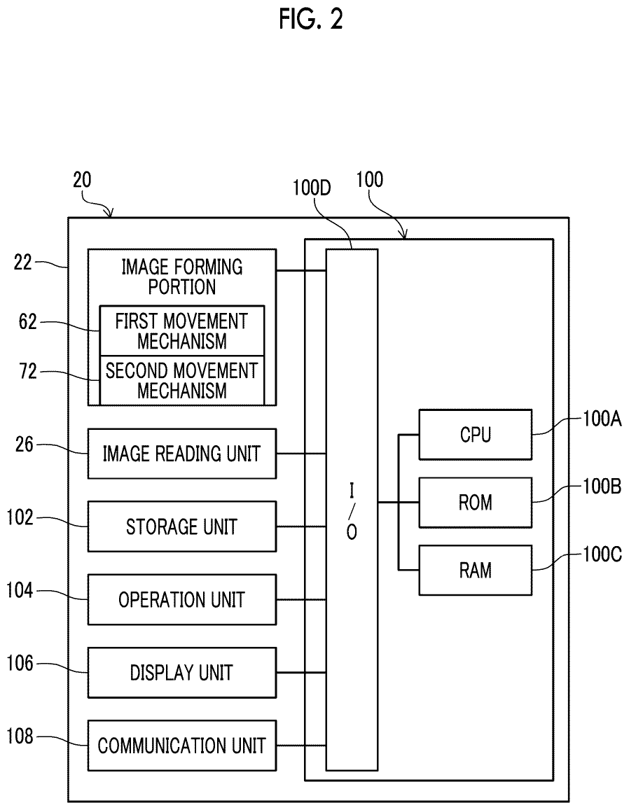

In addition, as shown in FIG. 2, the image forming apparatus 20 further includes a processor 100, a storage unit 102, an operation unit 104, a display unit 106, a communication unit 108, and the like.

### Processor 100

The processor 100 includes a Central Processing Unit (CPU) 100A, a Read Only Memory (ROM) 100B, a Random Access Memory (RAM) 100C, and an Input/Output interface (I/O) 100D. The processor 100 controls the operation of the entire image forming apparatus 20. For example, the ROM 100B stores various control programs, various parameters, and the like in advance. The RAM 100C is used as a work area or the like when various programs are executed by the CPU 100A.

The storage unit 102 stores various programs, various data, application programs, and the like for executing a printing process.

The operation unit 104 is used to input various types of information.

The display unit 106 is used to display various types of information.

The communication unit 108 is, for example, an interface for transmitting and receiving various types of data to and from an external apparatus such as a server. The communication unit 108 may be configured to directly communicate with each device by using, for example, short-range wireless communication such as Wi-Fi (registered trademark) or Bluetooth (registered trademark).

The image reading unit 26 has a function of reading an image of a manuscript set in the image forming apparatus 20. The image forming apparatus 20 according to the present exemplary embodiment includes an image reading unit 26 as an example, but the present disclosure is not limited to the configuration, and the image forming apparatus 20 may not include the image reading unit 26.

As shown in FIG. 2, each unit of the image forming apparatus 20 is electrically connected to each other by a system bus.

Next, the control of the operations of the first movement mechanism 62 and the second movement mechanism 72 by the processor 100 according to the present exemplary embodiment will be described.

The processor 100 may obtain each of the positions of the first surface forming roll 60 and the second surface forming roll 70 with respect to the virtual surface TP1 based on the information related to the particle diameter of the toner that forms the image, and may operate the first movement mechanism 62 and the second movement mechanism 72 to move to the positions at which the first surface forming roll 60 and the second surface forming roll 70 are respectively obtained.

Specifically, first, the processor 100 acquires information related to the particle diameter of the toner that forms an image. As an example, the information related to the particle diameter of the toner is read out from the ROM 100B, the RAM 100C, or the storage unit 102. The information related to the particle diameter of the toner may be acquired from a network or the like via the communication unit 108.

Next, the processor 100 obtains each of the positions of the first surface forming roll 60 and the second surface forming roll 70 with respect to the virtual surface TP1 based on the information related to the particle diameter of the toner. Specifically, the information related to the particle diameter of the toner is associated with each of the positions of the first surface forming roll 60 and the second surface forming roll 70 with respect to the virtual surface TP1, and the processor 100 acquires the positional information of the first surface forming roll 60 and the second surface forming roll 70 associated based on the information related to the particle diameter of the toner.

In the present exemplary embodiment, as an example, the processor 100 increases the distance L from the first surface forming roll 60 and the second surface forming roll 70 with respect to the virtual surface TP1 in the vertical direction in accordance with the size of the particle diameter of the toner. Specifically, the distance L between the first surface forming roll 60 and the second surface forming roll 70 in the apparatus up and down direction is increased. In other words, as the particle diameter of the toner increases, the contact surface TP2 is inclined with respect to the virtual surface TP1.

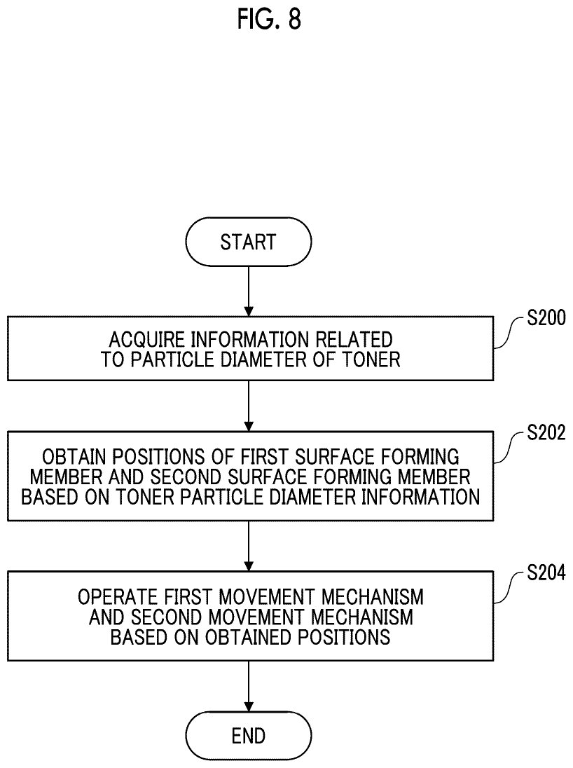

Next, an operation in a case of performing positional adjustment of each of the first surface forming roll 60 and the second surface forming roll 70 of the image forming apparatus 20 according to the present exemplary embodiment will be described with reference to a flowchart shown in FIG. 8.

First, the processor 100 acquires the information related to the particle diameter of the toner that forms the image (step S200).

Next, the processor 100 obtains each of the positions of the first surface forming roll 60 and the second surface forming roll 70 with respect to the virtual surface TP1 based on the information related to the particle diameter of the toner (step S202).

Then, the processor 100 operates the first movement mechanism 62 and the second movement mechanism 72 such that the first surface forming roll 60 and the second surface forming roll 70 move to each of the positions obtained in the step S202 (step S204).

In a case where each of the first surface forming roll 60 and the second surface forming roll 70 is moved to each of the obtained positions, the positional adjustment of each of the first surface forming roll 60 and the second surface forming roll 70 is completed. Then, the image forming apparatus 20 is operated to form an image on the recording medium P.

Next, the effects of the present exemplary embodiment will be described.

In the image forming apparatus 20 as the image forming system according to the present exemplary embodiment, the first surface forming roll 60 and the second surface forming roll 70 are disposed such that the pressure (nip pressure) in the nip portion N1 is higher at the nip portion N1 (in the present exemplary embodiment, the nip portion N1 (K)) positioned most downstream than at the nip portion N1 (in the present exemplary embodiment, the nip portion N1 (V)) positioned most upstream. Here, in the image forming apparatus 20, the color variation of the image transferred to the transfer belt 42 may be suppressed as compared with a configuration in which the first surface forming roll 60 and the second surface forming roll 70 are disposed such that the pressure in the nip portion N1 is the same between the nip portion N1 positioned most upstream and the nip portion N1 positioned most downstream.

In the image forming apparatus 20 according to the present exemplary embodiment, the first surface forming roll 60 and the second surface forming roll 70 are disposed such that the contact surface TP2 becomes a state of being inclined with respect to the virtual surface TP1. Therefore, in the image forming apparatus 20, the color variation of the image transferred to the transfer belt 42 may be suppressed as compared with a configuration in which the first surface forming roll 60 and the second surface forming roll 70 are disposed such that the contact surface TP2 and the virtual surface TP1 are parallel to each other.

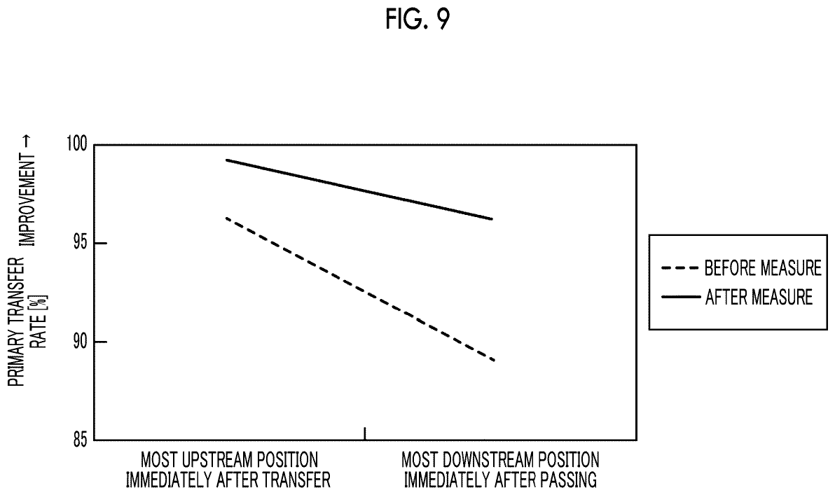

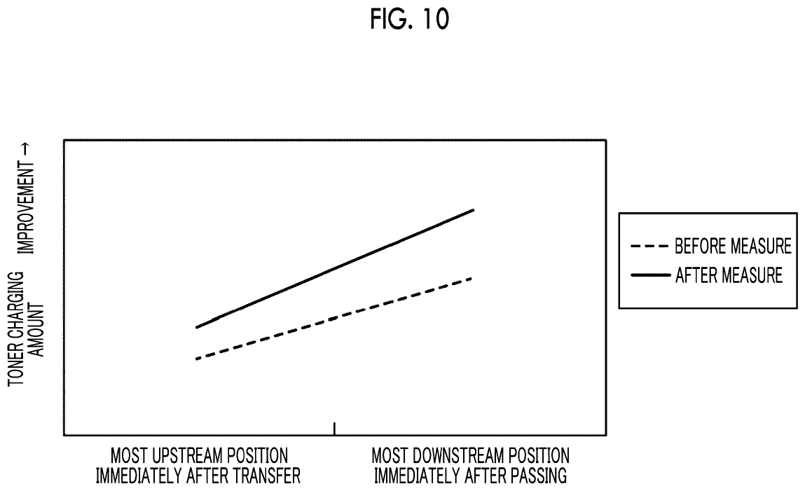

As shown in FIG. 7, in the image forming apparatus 20 according to the present exemplary embodiment, the contact portion of the first surface forming roll 60 with the transfer belt 42 is disposed on the side of the primary transfer roll 44 (lower side in the apparatus up and down direction) rather than the virtual surface TP1. Here, in the image forming apparatus 20, as compared with a configuration in which the contact portion of the first surface forming roll 60 with the transfer belt 42 is disposed on the side of the primary transfer roll 44 rather than the virtual surface TP1, the discharge start point P1 between the photosensitive drum 32 and the transfer belt 42 is separated from the discharge start point P2 between the transfer belt 42 and the primary transfer roll 44. Therefore, the discharge amount between the transfer belt 42 and the primary transfer roll 44 is reduced, that is, the charging amount of the toner is increased and the reverse transfer amount to most downstream photosensitive drum 32 is reduced. Accordingly, in the image forming apparatus 20, the color variation of the image transferred to the transfer belt 42 may be suppressed. In a case where the discharge start point P1 is separated from the discharge start point P2, the improvement in the primary transfer rate and the toner charging amount are known as shown in FIGS. 9 and 10. In addition, the term “after the measure” in the drawings refers to Examples in which the technology of the present disclosure is applied, and the term “before the measure” refers to Comparative Examples in which the technology of the present disclosure is not applied.

The image forming apparatus 20 according to the present exemplary embodiment includes the first movement mechanism 62 that moves the first surface forming roll 60 to the side of the primary transfer roll 44 (lower side in the apparatus up and down direction) with respect to the virtual surface TP1. Therefore, in the image forming apparatus 20, the color variation of the image transferred to the transfer belt 42 may be suppressed regardless of image forming conditions (conditions such as the thickness of the recording medium P, the unevenness of the recording medium P, the toner particle diameter, and the like) as compared with a configuration in which the positional relationship of the first surface forming roll 60 with respect to the virtual surface TP1 is fixed.

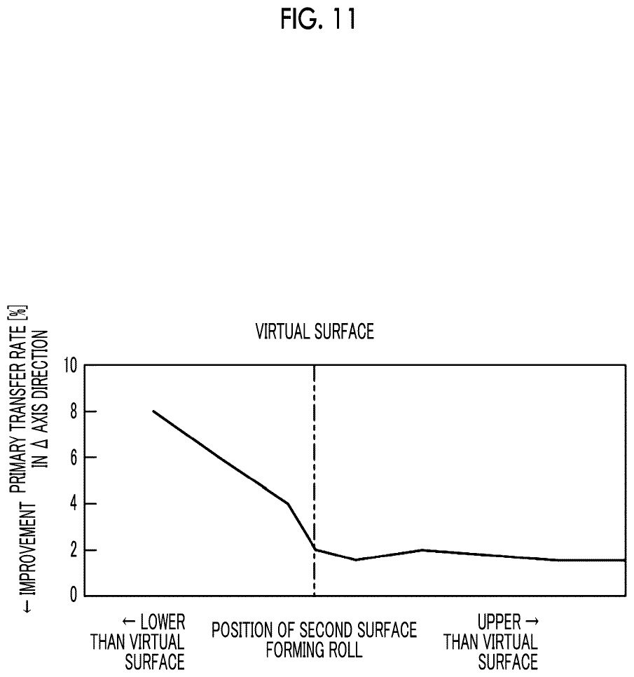

The image forming apparatus 20 according to the present exemplary embodiment includes the steering roll 48S that suppresses the inclination of the transfer belt 42, and the contact portion of the second surface forming roll 70 with the transfer belt 42 is disposed on a side opposite to the side of the primary transfer roll 44 (the upper side in the apparatus up and down direction) rather than the virtual surface TP1. Therefore, in the image forming apparatus 20, as compared with a configuration in which the contact portion of the second surface forming roll 70 with the transfer belt 42 is disposed on the side of the primary transfer roll 44 rather than the virtual surface TP1, the pressure pressing the transfer belt 42 against the photosensitive drum 32 positioned most downstream is increased. Therefore, the contact width reduction is suppressed in the transfer belt 42 in the rotation axial direction (width direction) due to the wrinkling of the transfer belt 42 formed in a case where the inclination of the transfer belt 42 is suppressed so that the difference in the transfer rate is reduced. Accordingly, in the image forming apparatus 20, the color variation of the image transferred to the transfer belt 42 may be suppressed. In a case where the contact portion of the second surface forming roll 70 with the transfer belt 42 is disposed on a side opposite to the side of the primary transfer roll 44 (upper side in the apparatus up and down direction) rather than the virtual surface TP1, the improvement in the primary transfer rate in the A axial direction is known as shown in FIG. 11.

The image forming apparatus 20 according to the present exemplary embodiment includes a second movement mechanism 72 that moves the second surface forming roll 70 to a side opposite to the side of the primary transfer roll 44 (an upper side in the apparatus up and down direction) with respect to the virtual surface TP1. Therefore, in the image forming apparatus 20, the color variation of the image transferred to the transfer belt 42 may be suppressed regardless of the image forming conditions (conditions such as the thickness of the recording medium P, the unevenness of the recording medium P, the toner particle diameter, and the like) as compared with a configuration in which the positional relationship of the second surface forming roll 70 with respect to the virtual surface TP1 is fixed.

In the image forming apparatus 20 according to the present exemplary embodiment, the first surface forming roll 60 and the second surface forming roll 70 are disposed such that the pressure of the nip portion N1 is higher in the nip portion N1 positioned on the downstream side than the nip portion N1 positioned on the upstream side in the circumferential direction A. Therefore, in the image forming apparatus 20, the color variation of the image transferred to the transfer belt 42 may be suppressed as compared with a configuration in which the first surface forming roll 60 and the second surface forming roll 70 are disposed such that the pressure in the nip portion N1 is the same between the nip portion N1 positioned most upstream as at the nip portion N1 positioned most downstream in the circumferential direction A.

In the image forming apparatus 20 according to the present exemplary embodiment, in the circumferential direction A, the nip width W1 (in the present exemplary embodiment, W1(K)) positioned most downstream is wider than the nip width W1 (in the present exemplary embodiment, W1(V)) positioned most upstream, and the nip width W2 (in the present exemplary embodiment, W2(K)) positioned most downstream is narrower than the nip width W2 (in the present exemplary embodiment, W2(V)) positioned most upstream. Therefore, in the image forming apparatus 20, the color variation of the image transferred to the transfer belt 42 may be suppressed as compared with a configuration in which the nip width W1 positioned most downstream is the same as the nip width W1 positioned most upstream and the nip width W2 positioned most downstream is the same as the nip width W2 positioned most upstream, in the circumferential direction A.

In the image forming apparatus 20 according to the present exemplary embodiment, in the photosensitive drums 32 adjacent to each other in the circumferential direction A, the nip width W1 positioned downstream is wider than the nip width W1 positioned upstream, and the nip width W2 positioned downstream is narrower than the nip width W2 positioned upstream. Therefore, in the image forming apparatus 20, the reverse transferring of the image to the most downstream photosensitive drum 32 can be suppressed by the pressure with which the transfer belt 42 is pressed against the most downstream photosensitive drum 32.

In the image forming apparatus 20 according to the present exemplary embodiment, the processor 100 obtains each of the positions of the first surface forming roll 60 and the second surface forming roll 70 with respect to the virtual surface TP1 based on the information related to the particle diameter of the toner that forms the image, and operates the first movement mechanism 62 and the second movement mechanism 72 to move the first surface forming roll 60 and the second surface forming roll 70 to the respective obtained positions. Therefore, in the image forming apparatus 20, the color variation of the image transferred to the transfer belt 42 may be suppressed as compared with a configuration in which each of the positions of the first surface forming roll 60 and the second surface forming roll 70 is fixed regardless of the particle diameter of the toner.

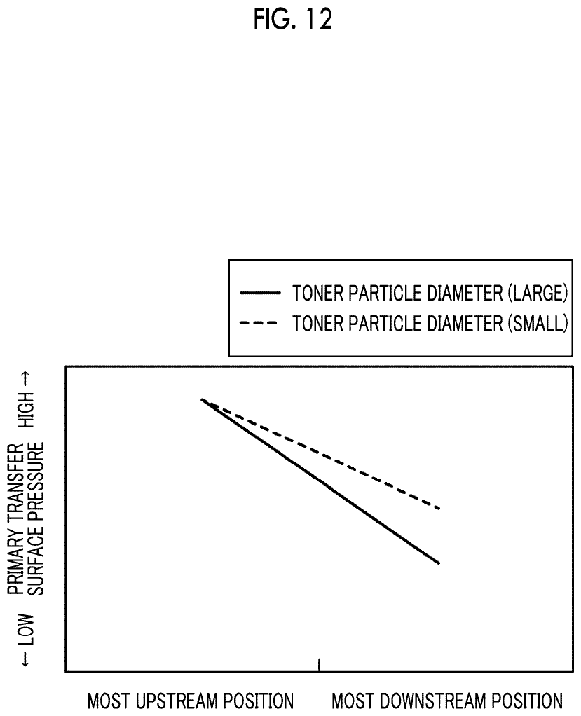

In addition, in the image forming apparatus 20 according to the present exemplary embodiment, the processor 100 increases the distance L between the first surface forming roll 60 and the second surface forming roll 70 in accordance with the size of the particle diameter of the toner. In the image forming apparatus 20, the distance L between the first surface forming roll 60 and the second surface forming roll 70 is increased in accordance with the size of the particle diameter of the toner, that is, the inclination of the straight line that connects the apexes 60P and 70P of the first surface forming roll 60 and the second surface forming roll 70 with respect to the virtual surface TP1 is increased. In the image forming apparatus 20, the color variation of the image transferred to the transfer belt 42 may be suppressed as compared with a configuration in which the distance L between the first surface forming roll 60 and the second surface forming roll 70 is constant regardless of the size of the particle diameter of the toner. In addition, in a case where the processor 100 increases the distance L between the first surface forming roll 60 and the second surface forming roll 70 in accordance with the size of the particle diameter of the toner, as shown in FIG. 12, the primary transfer pressure is improved. In FIG. 12, plain paper is used as the paper.

### Other Exemplary Embodiments

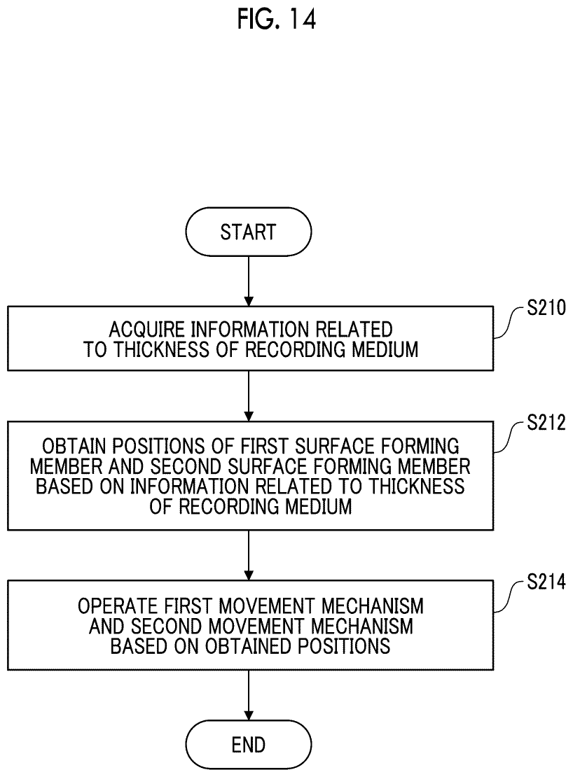

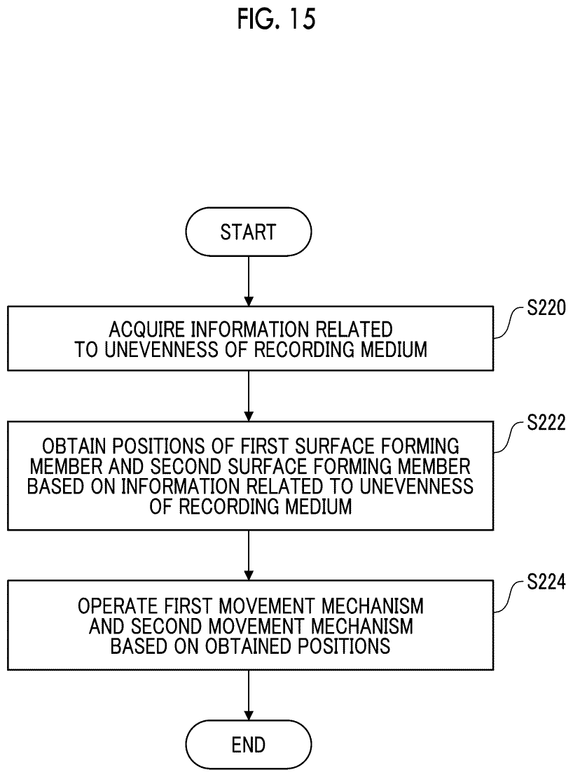

In the exemplary embodiment described above, the configuration is provided in which the processor 100 increases the distance L between the first surface forming roll 60 and the second surface forming roll 70 in accordance with the size of the particle diameter of the toner, but the present disclosure is not limited to the configuration. For example, as in the flowcharts shown in FIGS. 14 and 15, the processor 100 may increase the distance L between the first surface forming roll 60 and the second surface forming roll 70 based on information related to the thickness of the recording medium P to which the image is transferred or information related to the unevenness of the recording medium P. Hereinafter, an operation of the processor 100 will be described with reference to the flowcharts shown in FIGS. 14 and 15.

The processor 100 may obtain each of the positions of the first surface forming roll 60 and the second surface forming roll 70 with respect to the virtual surface TP1 based on the information related to the thickness of the recording medium P to which the image is transferred, and may operate the first movement mechanism 62 and the second movement mechanism 72 to move the first surface forming roll 60 and the second surface forming roll 70 to the respective obtained positions.

Specifically, first, the processor 100 acquires information related to a thickness of the recording medium P to which the image is transferred. As an example, the information related to the thickness of the recording medium P is read from the ROM 100B, the RAM 100C, or the storage unit 102. The information related to the thickness of the recording medium P may be acquired from a network or the like via the communication unit 108.

Next, the processor 100 obtains each of the positions of the first surface forming roll 60 and the second surface forming roll 70 with respect to the virtual surface TP1 based on the information related to the thickness of the recording medium P. Specifically, the information related to the thickness of the recording medium P is associated with each of the positions of the first surface forming roll 60 and the second surface forming roll 70 with respect to the virtual surface TP1, and the processor 100 acquires the positional information of the first surface forming roll 60 and the second surface forming roll 70 associated based on the information related to the thickness of the recording medium P.

In the present exemplary embodiment, as an example, the processor 100 increases the distance L from the first surface forming roll 60 and the second surface forming roll 70 with respect to the virtual surface TP1 in the vertical direction in accordance with the thickness of the recording medium P. Specifically, the distance L between the first surface forming roll 60 and the second surface forming roll 70 in the apparatus up and down direction is increased. In other words, as the thickness of the recording medium increases, the contact surface TP2 is inclined with respect to the virtual surface TP1.

Next, an operation in a case of performing the positional adjustment of each of the first surface forming roll 60 and the second surface forming roll 70 based on the information related to the thickness of the recording medium P to which the image is transferred using the image forming apparatus 20 according to the present exemplary embodiment will be described with reference to a flowchart shown in FIG. 14.

First, the processor 100 acquires the information related to the thickness of the recording medium P to which the image is transferred (step S210).

Next, the processor 100 obtains each of the positions of the first surface forming roll 60 and the second surface forming roll 70 with respect to the virtual surface TP1 based on the thickness of the recording medium P (step S212).

Then, the processor 100 operates the first movement mechanism 62 and the second movement mechanism 72 such that the first surface forming roll 60 and the second surface forming roll 70 move to the positions respectively obtained in step S212 (step S214).

In a case where each of the first surface forming roll 60 and the second surface forming roll 70 is moved to each of the obtained positions, the positional adjustment of each of the first surface forming roll 60 and the second surface forming roll 70 is completed. Then, the image forming apparatus 20 is operated to form an image on the recording medium P.

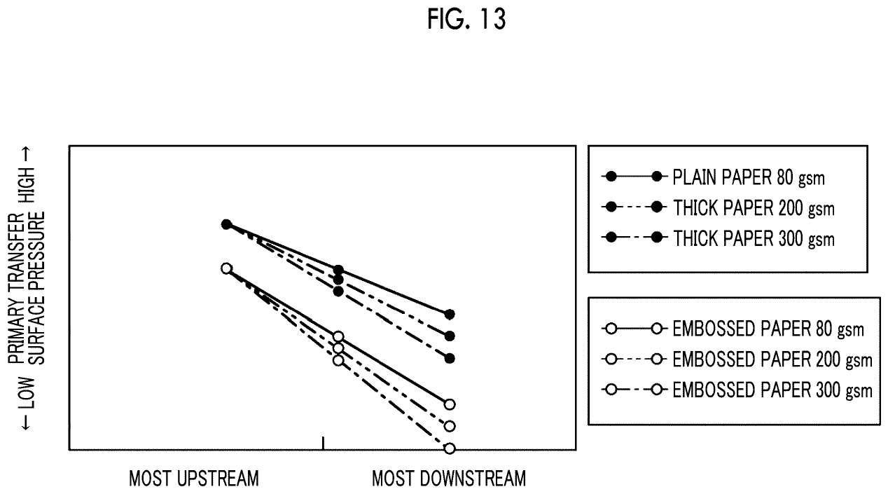

The processor 100 of the image forming apparatus 20 adjusts each of the positions of the first surface forming roll 60 and the second surface forming roll 70 based on the information related to the thickness of the recording medium P, so that the color variation of the image transferred to the transfer belt 42 may be suppressed as compared with a configuration in which each of the positions of the first surface forming roll 60 and the second surface forming roll 70 is fixed regardless of the thickness of the recording medium P. In addition, the processor 100 of the image forming apparatus 20 increases the distance L between the first surface forming roll 60 and the second surface forming roll 70 in accordance with the thickness of the recording medium P, that is, increases the inclination of the contact surface TP2 with respect to the virtual surface TP1, the color variation of the image transferred to the transfer belt 42 may be suppressed as compared with a configuration in which the distance L between the first surface forming roll 60 and the second surface forming roll 70 is constant regardless of the thickness of the recording medium P. In addition, in a case where the processor 100 increases the distance L between the first surface forming roll 60 and the second surface forming roll 70 in accordance with the thickness of the recording medium P, as shown in FIG. 13, the primary transfer pressure is improved. In the example of FIG. 13, thick paper is used as the paper.

The processor 100 may obtain each of the positions of the first surface forming roll 60 and the second surface forming roll 70 with respect to the virtual surface TP1 based on the information related to the unevenness of the recording medium P to which the image is transferred, and may operate the first movement mechanism 62 and the second movement mechanism 72 to move the first surface forming roll 60 and the second surface forming roll 70 to the respective obtained positions.

Specifically, first, the processor 100 acquires information related to the unevenness of the recording medium P to which the image is transferred. For example, the information related to the unevenness of the recording medium P is read from the ROM 100B, the RAM 100C, or the storage unit 102. The information related to the unevenness of the recording medium P may be acquired from a network or the like via the communication unit 108.

Next, the processor 100 obtains each of the positions of the first surface forming roll 60 and the second surface forming roll 70 with respect to the virtual surface TP1 based on the information related to the unevenness of the recording medium P. Specifically, the information related to the unevenness of the recording medium P is associated with each of the positions of the first surface forming roll 60 and the second surface forming roll 70 with respect to the virtual surface TP1, and the processor 100 acquires the positional information of the first surface forming roll 60 and the second surface forming roll 70 associated based on the information related to the unevenness of the recording medium P.

In the present exemplary embodiment, as an example, the processor 100 increases the distance L from the first surface forming roll 60 and the second surface forming roll 70 with respect to the virtual surface TP1 in the vertical direction in accordance with the size of the unevenness of the recording medium P. Specifically, the distance L between the first surface forming roll 60 and the second surface forming roll 70 in the apparatus up and down direction is increased. In other words, as the size of the unevenness of the recording medium P increases, the contact surface TP2 is inclined with respect to the virtual surface TP1.

Next, an operation in a case of performing the positional adjustment of each of the first surface forming roll 60 and the second surface forming roll 70 based on the information related to the unevenness of the recording medium P to which the image is transferred using the image forming apparatus 20 according to the present exemplary embodiment will be described with reference to a flowchart shown in FIG. 15.

First, the processor 100 acquires information related to the unevenness of the recording medium P to which the image is transferred (step S220).

Next, the processor 100 obtains each of the positions of the first surface forming roll 60 and the second surface forming roll 70 with respect to the virtual surface TP1 based on the unevenness of the recording medium P (step S222).

Then, the processor 100 operates the first movement mechanism 62 and the second movement mechanism 72 such that the first surface forming roll 60 and the second surface forming roll 70 move to the positions respectively obtained in step S222 (step S224).

In a case where each of the first surface forming roll 60 and the second surface forming roll 70 is moved to each of the obtained positions, the positional adjustment of each of the first surface forming roll 60 and the second surface forming roll 70 is completed. Then, the image forming apparatus 20 is operated to form an image on the recording medium P.

The processor 100 of the image forming apparatus 20 adjusts each of the positions of the first surface forming roll 60 and the second surface forming roll 70 based on the information related to the unevenness of the recording medium P, so that the color variation of the image transferred to the transfer belt 42 may be suppressed as compared with a configuration in which each of the positions of the first surface forming roll 60 and the second surface forming roll 70 is fixed regardless of the unevenness of the recording medium P. In addition, the processor 100 of the image forming apparatus 20 increases the distance L between the first surface forming roll 60 and the second surface forming roll 70, that is, increases the inclination of the contact surface TP2 with respect to the virtual surface TP1, in accordance with the size of the unevenness (for example, the width and the height difference) of the recording medium P, so that the color variation of the image transferred to the transfer belt 42 may be suppressed as compared with a configuration in which the distance L between the first surface forming roll 60 and the second surface forming roll 70 is constant regardless of the size of the unevenness of the recording medium P. In addition, in a case where the processor 100 increases the distance L between the first surface forming roll 60 and the second surface forming roll 70 in accordance with the unevenness of the recording medium P, as shown in FIG. 13, the primary transfer pressure is improved. In the example of FIG. 13, embossed paper is used as the paper.

In the image forming apparatus according to the exemplary embodiment described above, in a case where the processor 100 controls the first movement mechanism 62 and the second movement mechanism 72, the inclination of the transfer belt 42 can be automatically adjusted, but the present disclosure is not limited to the configuration. For example, the first movement mechanism 62 and the second movement mechanism 72 may be mechanisms capable of manually performing the height adjustment. In addition, by combining any two (or three) of the information related to the particle diameter of the toner, the information related to the thickness of the recording medium P, and the information related to the unevenness of the recording medium P, each of the positions of the first surface forming roll 60 and the second surface forming roll 70 may be adjusted based on the combined condition.

The present disclosure is not limited to the above-described exemplary embodiments, and various modifications, changes, and improvements can be made within a range without deviating from the gist of the present disclosure. For example, the above-described modification examples may be configured by combining a plurality of the modification examples as appropriate.

Regarding the above exemplary embodiments, the following supplementary notes will be further disclosed.

(((1)))

An image forming system comprising:
a plurality of image holding bodies that hold an image;
an intermediate transfer body that rotates and to which the image formed on the plurality of image holding bodies is transferred;
a plurality of transfer members that transfer the image formed on the plurality of image holding bodies to the intermediate transfer body;
a first surface forming member that is disposed upstream the plurality of image holding bodies in a rotation direction of the intermediate transfer body; and
a second surface forming member that is disposed downstream the plurality of image holding bodies in the rotation direction, and stabilizes surface formation of the intermediate transfer body together with the first surface forming member, wherein
the first surface forming member and the second surface forming member are disposed such that a pressure of a transfer portion formed by the image holding bodies and the transfer member via the intermediate transfer body is high in a transfer portion positioned most downstream as compared with a transfer portion positioned most upstream in the rotation direction.

(((2)))

The image forming system according to (((1))),
wherein the first surface forming member and the second surface forming member are disposed to be a state in which each of contact surfaces which are in contact with apexes of the first surface forming member and the second surface forming member is inclined with respect to a virtual surface which is in contact with apexes of the image holding bodies.

(((3)))

The image forming system according to (((2))),
wherein a contact portion of the first surface forming member with the intermediate transfer body is disposed on a side of the transfer member rather than the virtual surface.

(((4)))

The image forming system according to (((3))), further comprising:
a first movement mechanism that moves the first surface forming member to the side of the transfer member with respect to the virtual surface.

(((5)))

The image forming system according to (((2))), further comprising:
a suppression mechanism that is provided downstream the second surface forming member in the rotation direction, and suppresses inclination of the intermediate transfer body,
wherein a contact portion of the second surface forming member with the intermediate transfer body is disposed on a side opposite to a side of the transfer member rather than the virtual surface.

(((6)))

The image forming system according to (((5))), further comprising:
a second movement mechanism that moves the second surface forming member to the side opposite to the transfer member with respect to the virtual surface.

(((7)))

The image forming system according to (((1))) or (((2))),
wherein the first surface forming member and the second surface forming member are disposed such that the pressure of the transfer portion is high in a transfer portion positioned on a downstream side as compared with a transfer portion positioned on an upstream side in the rotation direction.

(((8)))

The image forming system according to any one of (((1))) to (((7)))),
wherein, in the rotation direction, a nip width between the image holding body positioned most downstream and the intermediate transfer body is wider than a nip width between the image holding body positioned most upstream and the intermediate transfer body, and
in the rotation direction, a nip width between the transfer member positioned most downstream and the intermediate transfer body is narrower than a nip width between the transfer member positioned most upstream and the intermediate transfer body.

(((9)))

The image forming system according to (((8))),
wherein, in the image holding bodies adjacent to each other in the rotation direction, a nip width between the image holding body positioned downstream and the intermediate transfer body is wider than a nip width between the image holding body positioned upstream and the intermediate transfer body, and
in the transfer members adjacent to each other in the rotation direction, a nip width between the transfer member positioned downstream and the intermediate transfer body is narrower than a nip width between the transfer member positioned upstream and the intermediate transfer body.

(((10)))

The image forming system according to (((2))), further comprising:
a first movement mechanism that moves the first surface forming member to a side of the transfer member with respect to the virtual surface;
a second movement mechanism that moves the second surface forming member to a side opposite to the transfer member with respect to the virtual surface; and
a processor that controls respective operations of the first movement mechanism and the second movement mechanism,
wherein the processor is configured to:
   obtain respective positions of the first surface forming member and the second surface forming member with respect to the virtual surface based on information related to a particle diameter of a toner that forms the image; and
   operate the first movement mechanism and the second movement mechanism to move the first surface forming member and the second surface forming member to the respective obtained positions.

(((11)))

The image forming system according to (((10))), wherein the processor is configured to:
increase a distance from the first surface forming member and the second surface forming member with respect to the virtual surface in a vertical direction in accordance with a size of the particle diameter of the toner.

(((12)))

The image forming system according to (((2))), further comprising:
a first movement mechanism that moves the first surface forming member to a side of the transfer member with respect to the virtual surface;
a second movement mechanism that moves the second surface forming member to a side opposite to the transfer member with respect to the virtual surface; and
a processor that controls respective operations of the first movement mechanism and the second movement mechanism,
wherein the processor is configured to:
   obtain respective positions of the first surface forming member and the second surface forming member with respect to the virtual surface based on information related to a thickness of a recording medium to which the image is transferred; and
   operate the first movement mechanism and the second movement mechanism to move the first surface forming member and the second surface forming member to the respective obtained positions.

(((13)))

The image forming system according to (((12))), wherein the processor is configured to:
increase a distance from the first surface forming member and the second surface forming member with respect to the virtual surface in a vertical direction in accordance with the thickness of the recording medium.

(((14)))

The image forming system according to (((2))), further comprising:
a first movement mechanism that moves the first surface forming member to a side of the transfer member with respect to the virtual surface;
a second movement mechanism that moves the second surface forming member to a side opposite to the transfer member with respect to the virtual surface; and
a processor that controls respective operations of the first movement mechanism and the second movement mechanism,
wherein the processor is configured to:
   obtain respective positions of the first surface forming member and the second surface forming member with respect to the virtual surface based on information related to unevenness of a recording medium to which the image is transferred; and
   operate the first movement mechanism and the second movement mechanism to move the first surface forming member and the second surface forming member to the respective obtained positions.

(((15)))

The image forming system according to (((14))), wherein the processor is configured to:
increase a distance from the first surface forming member and the second surface forming member with respect to the virtual surface in a vertical direction in accordance with a size of the unevenness of the recording medium.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming system comprising:
a plurality of image holding bodies that hold an image;
an intermediate transfer body that rotates and to which the image formed on the plurality of image holding bodies is transferred;
a plurality of transfer members that transfer the image formed on the plurality of image holding bodies to the intermediate transfer body;
a first surface forming member that is disposed upstream the plurality of image holding bodies in a rotation direction of the intermediate transfer body; and
a second surface forming member that is disposed downstream the plurality of image holding bodies in the rotation direction, and stabilizes surface formation of the intermediate transfer body together with the first surface forming member, wherein
the first surface forming member and the second surface forming member are disposed such that a pressure of a transfer portion formed by the image holding bodies and the transfer member via the intermediate transfer body is high in a transfer portion positioned most downstream as compared with a transfer portion positioned most upstream in the rotation direction.

2. The image forming system according to claim 1,
wherein the first surface forming member and the second surface forming member are disposed to be a state in which each of contact surfaces which are in contact with apexes of the first surface forming member and the second surface forming member is inclined with respect to a virtual surface which is in contact with apexes of the image holding bodies.

3. The image forming system according to claim 2,
wherein a contact portion of the first surface forming member with the intermediate transfer body is disposed on a side of the transfer member rather than the virtual surface.

4. The image forming system according to claim 3, further comprising:
a first movement mechanism that moves the first surface forming member to the side of the transfer member with respect to the virtual surface.

5. The image forming system according to claim 2, further comprising:
a suppression mechanism that is provided downstream the second surface forming member in the rotation direction, and suppresses inclination of the intermediate transfer body,
wherein a contact portion of the second surface forming member with the intermediate transfer body is disposed on a side opposite to a side of the transfer member rather than the virtual surface.

6. The image forming system according to claim 5, further comprising:
a second movement mechanism that moves the second surface forming member to the side opposite to the transfer member with respect to the virtual surface.

7. The image forming system according to claim 1,
wherein the first surface forming member and the second surface forming member are disposed such that the pressure of the transfer portion is high in a transfer portion positioned on a downstream side as compared with a transfer portion positioned on an upstream side in the rotation direction.

8. The image forming system according to claim 1,
wherein, in the rotation direction, a nip width between the image holding body positioned most downstream and the intermediate transfer body is wider than a nip width between the image holding body positioned most upstream and the intermediate transfer body, and
in the rotation direction, a nip width between the transfer member positioned most downstream and the intermediate transfer body is narrower than a nip width between the transfer member positioned most upstream and the intermediate transfer body.

9. The image forming system according to claim 8,
wherein, in the image holding bodies adjacent to each other in the rotation direction, a nip width between the image holding body positioned downstream and the intermediate transfer body is wider than a nip width between the image holding body positioned upstream and the intermediate transfer body, and
in the transfer members adjacent to each other in the rotation direction, a nip width between the transfer member positioned downstream and the intermediate transfer body is narrower than a nip width between the transfer member positioned upstream and the intermediate transfer body.

10. The image forming system according to claim 2, further comprising:
a first movement mechanism that moves the first surface forming member to a side of the transfer member with respect to the virtual surface;
a second movement mechanism that moves the second surface forming member to a side opposite to the transfer member with respect to the virtual surface; and
a processor that controls respective operations of the first movement mechanism and the second movement mechanism,
wherein the processor is configured to:
obtain respective positions of the first surface forming member and the second surface forming member with respect to the virtual surface based on information related to a particle diameter of a toner that forms the image; and
operate the first movement mechanism and the second movement mechanism to move the first surface forming member and the second surface forming member to the respective obtained positions.

11. The image forming system according to claim 10, wherein the processor is configured to:
increase a distance from the first surface forming member and the second surface forming member with respect to the virtual surface in a vertical direction in accordance with a size of the particle diameter of the toner.

12. The image forming system according to claim 2, further comprising:
a first movement mechanism that moves the first surface forming member to a side of the transfer member with respect to the virtual surface;
a second movement mechanism that moves the second surface forming member to a side opposite to the transfer member with respect to the virtual surface; and
a processor that controls respective operations of the first movement mechanism and the second movement mechanism,
wherein the processor is configured to:
obtain respective positions of the first surface forming member and the second surface forming member with respect to the virtual surface based on information related to a thickness of a recording medium to which the image is transferred; and
operate the first movement mechanism and the second movement mechanism to move the first surface forming member and the second surface forming member to the respective obtained positions.

13. The image forming system according to claim 12, wherein the processor is configured to:
increase a distance from the first surface forming member and the second surface forming member with respect to the virtual surface in a vertical direction in accordance with the thickness of the recording medium.

14. The image forming system according to claim 2, further comprising:
a first movement mechanism that moves the first surface forming member to a side of the transfer member with respect to the virtual surface;
a second movement mechanism that moves the second surface forming member to a side opposite to the transfer member with respect to the virtual surface; and
a processor that controls respective operations of the first movement mechanism and the second movement mechanism,
wherein the processor is configured to:
obtain respective positions of the first surface forming member and the second surface forming member with respect to the virtual surface based on information related to unevenness of a recording medium to which the image is transferred; and
operate the first movement mechanism and the second movement mechanism to move the first surface forming member and the second surface forming member to the respective obtained positions.

15. The image forming system according to claim 14, wherein the processor is configured to:
increase a distance from the first surface forming member and the second surface forming member with respect to the virtual surface in a vertical direction in accordance with a size of the unevenness of the recording medium.
